(19) United States
(12) Patent Application Publication
(10) Pub. No.: US 2011/0214092 A1
(43) Pub. Date: Sep. 1, 2011

(54) System and Method for Management of User Interactions Using Configurable Listeners in a Data Processing System

(75) Inventors: Paul A. Palmer, Eagan, MN (US); Kaushal Patankar, Pune (IN); Sanjay Maneklal Patel, Canton, MI (US)

(73) Assignees: Siemens Product Lifecycle Management Software Inc., Plano, TX (US); Siemens Product Lifecycle Management Software (India) Private Limited, Pune (IN)

(21) Appl. No.: 12/713,809

(22) Filed: Feb. 26, 2010

(51) Int. Cl. G06F 3/033

(52) U.S. Cl. 715/863

(57) ABSTRACT

A system, method, and computer program product for management of user interactions with a data processing system. A method includes loading a listener dependency definition for a user interaction listener in a data processing system, and initializing listener lookup information for the user interaction listener. The method includes detecting a defined user interaction event by the user interaction listener, and handling the detected defined user interaction event by performing a corresponding defined action.

### TECHNICAL FIELD

The present disclosure is directed, in general, to systems and methods for computer-aided design, manufacturing, engineering, modeling, and visualization (individually and collectively, “CAD” and “CAD systems”), to systems and methods for product lifecycle management (“PLM”) systems, and to managing user interactions with a data processing system.

### BACKGROUND OF THE DISCLOSURE

Many manufactured products are first designed and modeled in CAD systems and PLM systems. Improved systems are desirable.

### SUMMARY OF THE DISCLOSURE

Various disclosed embodiments include a system, method, and computer program product for management of user interactions with a data processing system. A method includes loading a listener dependency definition for a user interaction listener in a data processing system, and initializing listener lookup information for the user interaction listener. The method includes detecting a defined user interaction event by the user interaction listener, and handling the detected defined user interaction event by performing a corresponding defined action.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a data processing system in which an embodiment can be implemented;

FIG. 2 depicts a process in accordance with a disclosed embodiment;

FIG. 3 depicts a flowchart of a process in accordance with disclosed embodiments;

FIG. 4 depicts a flowchart of a process in accordance with disclosed embodiments; and

FIG. 5 shows an example of a PropertyEventDispatcher class in accordance with various embodiments.

### DETAILED DESCRIPTION

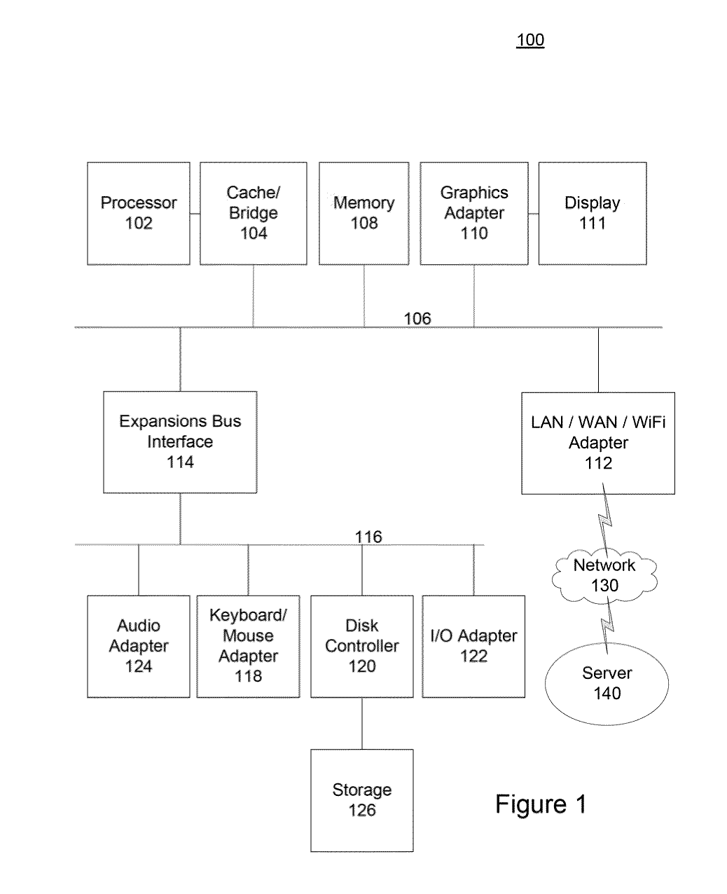

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

In the development of declarative models of software user interfaces, it is often difficult to declaratively specify the behavior and dynamics of a user interface along with traditional static layout and styling. User interface developers must often address programmatic logic outside of the user interface definition itself to ensure that user interactions with one control in a user interface will cause appropriate updates to the state or nature of other controls within the interface in such an arrangement. Since there is no specific connection or knowledge between the user interface definition and the programmer's code, it is at best a snapshot of a single path through the interface and cannot be readily modified or maintained without rewriting the code when even small modifications to the declarative model are needed or desired.

Disclosed embodiments provide user interface developers a mechanism and design that allows for more tightly integrating the static definition of the user interface with the code that responds to user gestures. Many times, the ability to make changes to the user interface and modify the relationships and interaction patterns between controls in the user interface is a critical part of setting up the software system uniquely for each customer. Conventional systems are limited to either time-consuming and expensive development of custom software for each customer desiring even small changes, or the release of source code so that customers can make the necessary modifications themselves. Disclosed embodiments provide systems and methods that can quickly and easily provide custom software capabilities to customers without releasing source code. Disclosed embodiments include a mechanism that loosely couples the UI definition with the executable code controlling the UI's behavior, so that developers are also spared the enormous expense of developing and maintain custom code implementations for each customer.

FIG. 1 depicts a block diagram of a data processing system in which an embodiment can be implemented as either or both of a development system and a system for executing methods as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system can be modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

Disclosed embodiments include systems and methods that loosely-couple a static user interface definition with the executable software code that specifies the behavior and interaction patterns that react to user gestures within the interface.

According to various embodiments, this is accomplished by using a new XML tag and associated attributes within an XML schema for declarative user interface specification. The disclosed XML tag, referred to herein as a “listensTo” tag, provides the ability to declaratively link two or more controls on a user interface, and to specify via one of its attributes the executable code which is to be invoked on specific user gestures.

A single static control definition can be augmented with as many “listensTo” tags as necessary to fully specify any range of reactions to user gestures occurring on any number of other controls within the user interface. By specifying the executable code invocation at the granular combination of the required IU control and user gesture (for example, as a “uiControl::userGesture” definition), a virtually unlimited number of paths or routes through the user interface can be specified at each customer installation without the need to maintain custom copies of a monolithic executable module containing ALL of the user interface behavior for each particular customer.

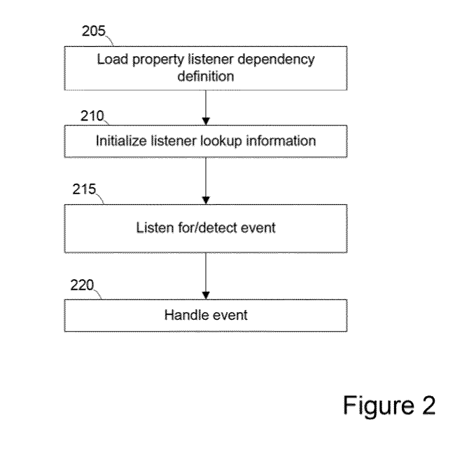

FIG. 2 depicts a process in accordance with a disclosed embodiment. FIG. 2 illustrates how the various registered user-interaction events are managed through a common dispatcher of a data processing system which orchestrates the various event handling and delegating the event processing to the correct registered handlers.

The system receives a property listener dependency definition for a user interaction listener (step 205). While this example is described in terms of a single listener, those of skill in the art recognize that any number of listeners can be used. This step can include defining the rendering required for the listener and its corresponding action, identifying dependent properties and events, and specifying the listensTo tag.

The system initializes the listener lookup information for the listener (step 210). This step can include creating a map of dependent properties, events, and handlers, and registering a dispatcher for dependent properties. The dispatcher manages the delegation to the registered handler.

The system listens for defined user interaction events, such as gestures, button presses of a mouse or touchpad, screen touches, key presses, a user input, and otherwise, using the listener (step 215). As part of this step, the system detects a defined event.

The system handles the event according to the property listener dependency definition for the listener (step 220), by performing the defined action. The step can include the RegisteredEvent event handlers dispatching or delegating the event, and EventHandlers performing the defined action corresponding to the event.

When the table properties are used, it is preferable to render the table details based on the changes to the table definition and validate the table data based on changes to other dependent properties. For example if there is a change in the number of rows (addition or deletion) at runtime the table on the panel should get updated with the corresponding new table definition or if maxValues property is updated then it should not be less than minValues and so on. Currently the property widgets on the properties dialog do not have dynamic behavior. All the property widgets on the property dialog are static in nature.

The disclosed property listener mechanism forces these widgets to re-render at runtime or to do data validations based on changes to the independent property widgets. This is a generic mechanism and can be applied to any property within a given page of the properties dialog. To achieve this, changes to the user interface definition, such as a stylesheet, are used in combination with some utility classes to handle the event propagation and handling. Examples of the user interface definition changes and the new classes, in accordance with various embodiments, are given as below:

```
<rendering>
  <Views>properties</views>
  <page title=”TableProperties” titleKey=”TableProperties”>
    <property name=”tableDefinition” renderingHunt=”tableDefinitionPanel”/>
    <property name=”maxValues” renderingHint=”PropertyTable”>
      <listensTo name=”tableDefinition” event=”lostFocus” java=”stylesheet.EventHandler” />
      <listensTo name=”minValues” event=”lostFocus” java=”stylesheet.EventHandler” />
      <listensTo name=”resolution” event=”lostFocus” java=”stylesheet.EventHandler” />
    </property>
  </page>
</rendering>
```

In this example, the listensTo tag indicates the property dependency. For example, the maxValues property listens to any changes happening to the tableDefinition, minValues and resolution property widgets.

In a typical implementation, the ListensTo tag will only be a child of a property/control tag and should not appear anywhere else in the user interface definition. The name attribute of the listensTo tag indicates the control on which the current control listens. The event attribute indicates the event to be processed. The value of java attribute is a fully qualified class name (simplified in this example) which is responsible for handling the given event. The java attribute is a programming-language-specific form of the more generic “using” attribute which can be used to indicate both the programming language and class/method which is responsible for handling the given event. This is an extension point where user can provide any customization by specifying their own event handler class.

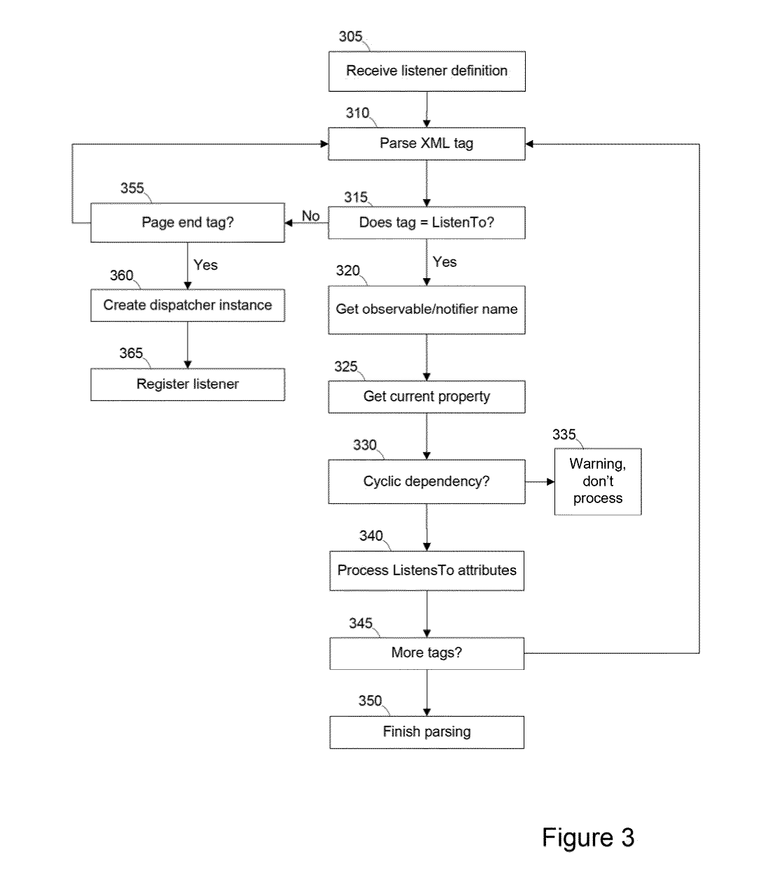

FIG. 3 depicts a flowchart of a process in accordance with disclosed embodiments. FIG. 3 depicts a process performed by the data processing system to handle an event using a configurable listener as disclosed herein.

The system receives a listener definition including, in some embodiments, one or more XML tags as described herein (step 305). Receiving, as used herein, can include loading from a storage, receiving over a network or otherwise from another data processing system, receiving from a different application or process executing on the same data processing system, receiving from a user, or otherwise.

The system parses the XML tag (step 310). The system determines if the tag is a ListensTo tag as described herein (step 315). If it is not, the system determines if the tag is a user interface definition end tag (step 355), such as a page end tag. If not, the system repeats to step 310 for the next tag. If it is a user interface definition end tag (at step 355), the system creates a dispatcher instance (step 360), and registers a listener (step 365).

If the tag is a ListensTo tag (at step 315), the system gets a corresponding observable/notifier name (step 320), and gets the current property or control (observer/subscriber) corresponding to the tag (step 325).

The system determines if there is cyclic dependency between the observable and observer widgets (step 330). If there is, the system logs a warning and does not process the information for this particular instance of the ListensTo tag (step 335).

If there is not cyclic dependency (at step 330), the system processes the attribute information from the ListensTo tag (step 340), that can include name, event, and java or using attributes as described herein.

The system determines if there are additional tags to processed (step 345) and if so, repeats to step 310. If there are no additional tags, the system is finished parsing (step 350) the user interface definition.

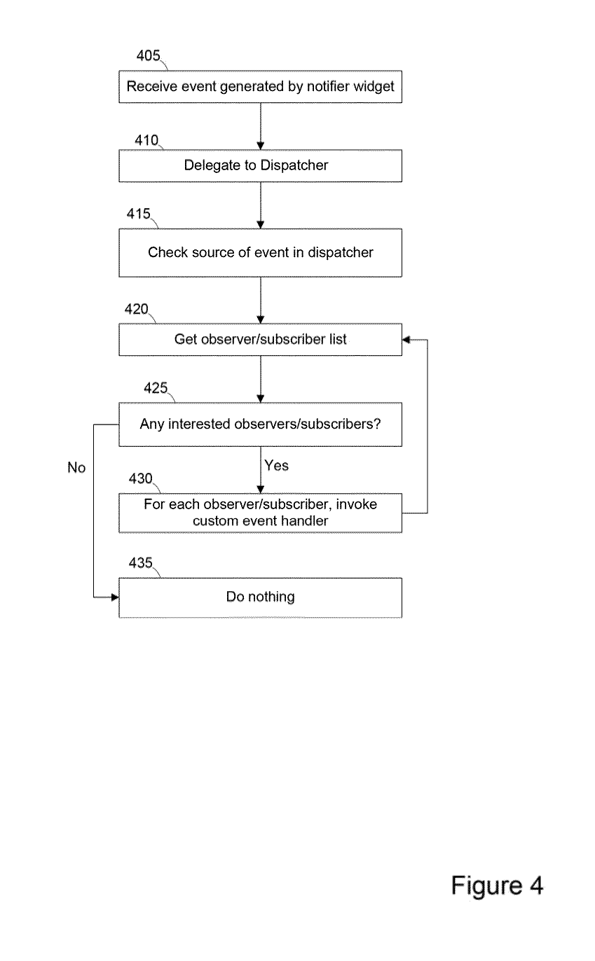

FIG. 4 depicts a flowchart of a process in accordance with disclosed embodiments. FIG. 4 depicts a process performed by the data processing system to handle an event as disclosed herein.

The system receives the event generated by the notifier widget or control (step 405).

The system delegates the event to a dispatcher (step 410). The system checks the source of the event in the dispatcher (step 415).

The system gets the observer/subscriber list for the event (step 420). The system determines if there are any observers/subscribers registered for the particular control/event combination detected (step 425).

If there are registered observers/subscribers, the system invokes a custom event handler, as defined by the ListensTo tag, for each observer/subscriber (step 430).

If there are no registered observers/subscribers (at step 425), the system does nothing (step 435).

In various embodiments, PropertyListenerInfo is a utility class that encapsulates information related to the ListensTo tag. PropertyListenerInfo is instantiated while the user interface definition is getting parsed for the ListensTo tag. In a typical implementation, there is one instance of this class corresponding to one observable/notifier property widget or control. The class is used for registering the event listeners for each of the observable property widgets or controls. The information carried by this class can include the property name and widget or control of the observable widget, property name and widget of the observer widget or control, the event type, and the list of observers/subscribers and corresponding custom event handler keys.

In various embodiments, PropertyEventDispatcher is used as a generic listener class to all the events generated by property widgets or controls.

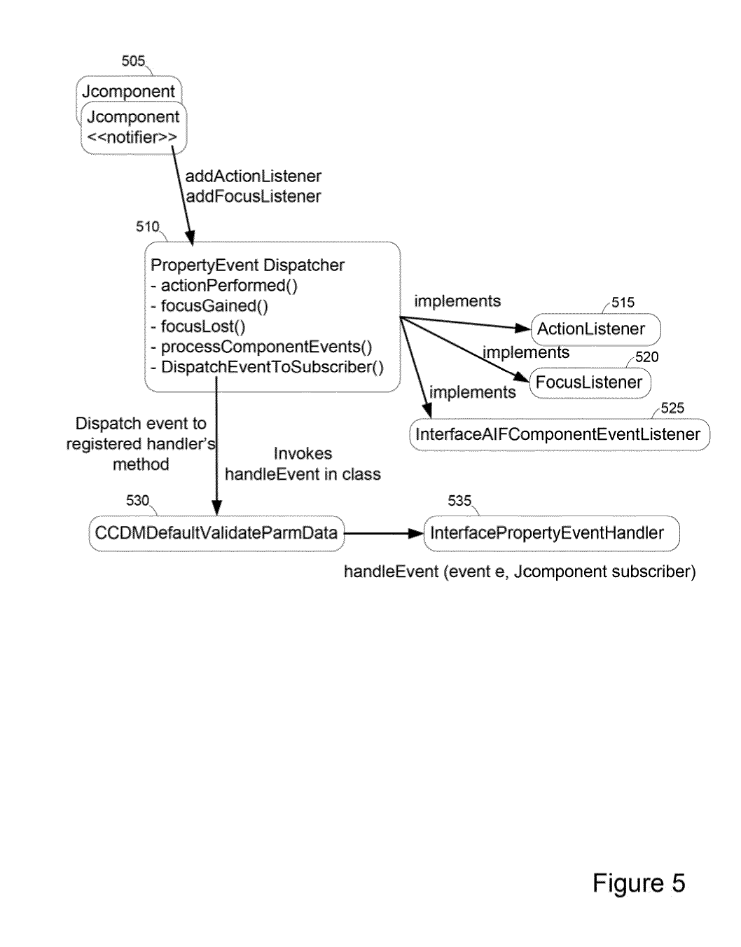

FIG. 5 shows an example of the PropertyEventDispacher class, in accordance with various embodiments, and illustrates how various notifying widgets or controls will add this dispatcher as an event listener which would dispatch the event to the appropriate event handlers for the individual widgets or controls that are interested in the notifier's events.

Here, notifying widget Jcomponents 505 add listeners to dispatcher 510. In this example, an ActionListener and a FocusListener are added to the dispatcher 510.

Dispatcher 510 implements the ActionListener 515 and FocusListener 520. Dispatcher 510 also implements an InterfaceAIComponentEventListener 525 to support ActionListener 515 and FocusListener 520.

When a listener detects an event, the dispatcher 510 dispatches the event to the registered handler, in this example to CCDMDefaultValidateParmData 530, which in turn calls the InterfacePropertEventHandler 535 to handle the event as required.

Though FIG. 5 shows various interfaces that have been implemented in a specific programming language and system, various embodiments are not limited to these specific interfaces. Preferably, a given implementation implements only those interfaces as required for addressing the use cases of the specific implementation, and other interfaces can be implemented as and when there is need for support of those events.

This class implements all the listener interfaces required for the supporting events. Another task of this class is to dispatch the event to the respective classes mentioned in the “using” attribute of the registered observers/subscribers. This acts as a generic event handler for any event generated by any observable/notifier.

The PropertyEventDispacher class can synchronously dispatch events from the user interface event thread by invoking the handleEvent methods in the registered handlers. This can be done synchronously as part of the user interface thread so that when a given event is in progress the user is not allowed to change any other widgets or controls or to perform any other user gesture that would modify the state of the user interface.

Various embodiments also include an InterfacePropertyEventHandler interface. Any class which acts as a custom handler for the event-subscriber combination can implement this interface. This interface has a “handleEvent” method which, when implemented by the custom classes, is invoked through the PropertyEventDispatcher class.

Preferably, no programmatic methods requiring access to remote services or systems are invoked from the handleEvent method as this method is invoked by the PropertyEventDispatcher in the user interface thread so that user is not allowed to change any other widget while the event is still in process. The effect of accessing remote systems or services from the user interface thread will be to prevent any user gestures until the remote service or system returns control to the local system. End users of such a system will potentially perceive this as a failure or hang condition on the local user interface.

Various embodiments disclosed herein provide a great deal of configuration flexibility by adopting a strategy pattern that allows easy replacement of listeners and reaction logic without having to modify or subclass other code. Those skilled in the art will recognize the strategy pattern as a common approach to contextually extending or replacing executable code at runtime. Different handlers can be registered for different events which can be easily tailored for individual operating scenarios and needs.

Various embodiments associate an executable class with a specific user interface control and an event on that same control. This allows customization of a behavior that applies strictly to the control it is configured on. In contrast, one use and value of the “ListensTo” implementations associate an executable command with an event on a user interface control other than itself. That is, a different user interface control can “listen to” the events on a widget or control other than itself and then take its own independent action that the other widget or control knows nothing about. It is possible to have a control listen to its own events with a “listensTo” implementation, but that is not the primary use.

As another example, think of dependent lists of values (LOVs). When the selection in a list box control changes, it is often desirable for another list box to repopulate or reselect based on the new selection in the first list box. The disclosed embodiments allow the developer to configure the second/dependent LOV to listen to the selectionChanged event occurring on the primary LOV. The code pointed to by the dependent LOVs “ListensTo” tag and using attribute can pull the primary LOV's new value from the event object and use that as the main criterion driving the update or refresh of the dependent LOV.

Another advantage of some embodiments is the way in which the user interface controls are coupled together at runtime as opposed to being coupled at design time, which is typical in traditional implementations not implementing the disclosed ListensTo construct. For example, to control a dependent LOV in a traditional implementation, event handling code on an independent or primary control would need to point to a class that has a priori knowledge of the dependent control and the dependent control would need to have a specific refresh method that the primary control can call in its selectionChanged event handler. Using the “ListensTo” model, the primary control knows nothing about which or how many controls are dependent on it. The event handler that gets executed on the primary control is responsible for performing updates on itself based on the event, and then “announcing” the event to all registered listeners, who can then do whatever their “listensTo” handler for that control::event combination is coded to do. This approach overcomes the need for a priori knowledge by either primary or dependent controls and allows new dependent controls, new dependent behaviors, and new event types on the primary control to be added or customized into the system without any need to change either the primary control's event handlers or any existing dependent controls' listeners. The ListensTo construct also supports incremental growth in sophistication of behavior because a single dependent control can have both multiple “listensTo” tags listening to different events on a single primary control and separate tags listening to events on any number of other controls on the same user interface.

Further, in some embodiments, when the user interface definition is parsed, each control specified on the user interface is instantiated and any “listensTo” tags are populated into a simple table/array/map structure that holds the name of the control it wants to listen to, the name of the event to react to, and the name of the class and the name of the methods or class::method that contains the reaction logic for that particular control::event combination. Once the complete user interface definition has been parsed, the system goes through all of the instantiated controls and uses the “listensTo” table to dynamically register and instantiate the appropriate listeners on the controls and events as necessary. Once that is set up the runtime interplay between the primary and dependent controls proceeds just as it would have if the system had perfect a priori knowledge with hard-coded handler/listener registration and instantiation

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described, as can be configured to perform processes as described herein. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of executable instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method for management of user interactions with a data processing system, comprising:
receiving a listener dependency definition for a user interaction listener in a data processing system;
initializing listener lookup information for the user interaction listener in the data processing system;
detecting a defined user interaction event by the user interaction listener in the data processing system; and
handling the detected defined user interaction event by performing a corresponding defined action by the data processing system.

2. The method of claim 1, wherein initializing listener lookup information includes creating a map of at least one of dependent properties, events, and handlers.

3. The method of claim 1, wherein initializing listener lookup information includes registering a dispatcher for at least one dependent property.

4. The method of claim 1, wherein receiving a listener dependency definition includes defining a rendering and the corresponding defined action for the user interaction listener.

5. The method of claim 1, wherein receiving a listener dependency definition includes identifying dependent properties and events corresponding to the user interaction listener.

6. The method of claim 1, wherein handling the detected defined user interaction event includes dispatching an event by an event handler.

7. The method of claim 1, wherein handling the detected defined user interaction event includes performing the defined action using an event handler.

8. A data processing system comprising a processor and accessible memory, the data processing system particularly configured to perform the steps of:
receiving a listener dependency definition for a user interaction listener;
initializing listener lookup information for the user interaction listener;
detecting a defined user interaction event by the user interaction listener; and
handling the detected defined user interaction event by performing a corresponding defined action.

9. The data processing system of claim 8, wherein initializing listener lookup information includes creating a map of at least one of dependent properties, events, and handlers.

10. The data processing system of claim 8, wherein initializing listener lookup information includes registering a dispatcher for at least one dependent property.

11. The data processing system of claim 8, wherein receiving a listener dependency definition includes defining a rendering and the corresponding defined action for the user interaction listener.

12. The data processing system of claim 8, wherein receiving a listener dependency definition includes identifying dependent properties and events corresponding to the user interaction listener.

13. The data processing system of claim 8, wherein handling the detected defined user interaction event includes dispatching an event by an event handler.

14. The data processing system of claim 8, wherein handling the detected defined user interaction event includes performing the defined action using an event handler.

15. A computer-readable storage medium encoded with computer-executable instructions that, when executed, cause a data processing system to perform the steps of:
receiving a listener dependency definition for a user interaction listener;
initializing listener lookup information for the user interaction listener;
detecting a defined user interaction event by the user interaction listener; and
handling the detected defined user interaction event by performing a corresponding defined action.

16. The computer-readable storage medium of claim 15, wherein initializing listener lookup information includes creating a map of at least one of dependent properties, events, and handlers.

17. The computer-readable storage medium of claim 15, wherein initializing listener lookup information includes registering a dispatcher for at least one dependent property.

18. The computer-readable storage medium of claim 15, wherein receiving a listener dependency definition includes defining a rendering and the corresponding defined action for the user interaction listener.

19. The computer-readable storage medium of claim 15, wherein receiving a listener dependency definition includes identifying dependent properties and events corresponding to the user interaction listener.

20. The computer-readable storage medium of claim 15, wherein handling the detected defined user interaction event includes dispatching an event by an event handler.

21. The computer-readable storage medium of claim 15, wherein handling the detected defined user interaction event includes performing the defined action using an event handler.
